(19) United States
(12) Patent Application Publication
(10) Pub. No.: US 2018/0209900 A1
(43) Pub. Date: Jul. 26, 2018

(54) SYSTEM AND METHOD OF INFERRING THE QUALITY LEVEL OF MEDICINES

(71) Applicant: Western New England University, Springfield, MA (US)

(72) Inventors: Christian Salmon, Northampton, MA (US); Ronny Priefer, Wilbraham, MA (US)

(21) Appl. No.: 15/873,229

(22) Filed: Jan. 17, 2018

Related U.S. Application Data
(60) Provisional application No. 62/448,617, filed on Jan. 20, 2017.

(51) Int. Cl. G01N 21/31; G01N 1/38; G01N 1/28

(52) U.S. Cl. CPC G01N 21/314; G01N 1/38; G01N 1/286; G01N 2021/3133; G01N 2021/3137; G01N 2021/3148; G01N 2001/2866

(57) ABSTRACT

A method and system of inferring a medicine quality level is provided. The method includes diluting the medicine with a solvent. Levels of absorption of UV light are measured at a plurality of predetermined wavelengths. The quality of the medicine is categorized based at least in part on an ELECTRE TRI process using the measured absorption levels. The category is displayed to an operator.

### BACKGROUND

The subject matter disclosed herein relates to a system and method of inferring the quality of pharmaceutical medicines, and in particular to a system and method for inferring low quality or counterfeit medications in in low and middle income countries (LMIC).

The level of control and regulation of pharmaceutical medicines varies widely throughout the world. In some countries, such as the United States for example, extensive and robust systems have been created to ensure that medicines provided to patients are of a desired quality level (e.g. has sufficient active compounds, no impurities) and not a counterfeit (e.g. substantially no active pharmaceutical compounds). Developed countries also have robust distribution systems that includes education of pharmacists so the medicines are stored properly and degraded medicines are not given to patients.

Many LMIC economies do not have these systems in place. As a result, many medicines may be of low quality, meaning it contains low concentrations of the active pharmaceutical compound, or impurities. Impurities may be a function of poor manufacturing quality control or point-of-sale storage conditions (exposure to moisture, sunlight, heat, or beyond expiration date). These countries also have issues with counterfeit pharmaceuticals, meaning pharmaceuticals that are intentionally manufactured with substantially no active pharmaceutical compound(s), and are distributed and/or sold with this knowledge. It has been estimated that 30% of the medications on the global market are of low quality or are counterfeit.

Accordingly, while existing medicine quality control systems and methods are suitable for their intended purposes the need for improvement remains, particularly in providing a system and method for inferring a quality level of medicines using system and materials that are suitable for use in LMIC.

### BRIEF DESCRIPTION

According to one aspect of the disclosure, a method for inferring the quality level of a medicine is provided. The method includes diluting the medicine with a solvent. Levels of absorption of UV light are measured at a plurality of predetermined wavelengths. The quality of the medicine is categorized based at least in part on an ELECTRE TRI process using the measured absorption levels. The category is displayed to an operator.

According to another aspect of the disclosure, a system for inferring the quality level of a medicine is provided. The system includes a light source that transmits UV light at a plurality of predetermined wavelengths. A sensor is provided that measures the UV light. A sample holder is operable to receive a sample of the medicine diluted by a solvent, the sample holder disposed between the sensor and the light source. One or more processors that execute non-transitory computer readable instructions, the computer readable instructions comprising: measuring levels of absorption of UV light at the plurality of predetermined wavelengths; categorizing the quality of the medicine based at least in part on an ELECTRE TRI process using the measured absorption levels; and displaying the category to an operator.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a flow diagram of a process for inferring the quality of medicines;

FIG. 2 is a schematic diagram of a system for inferring the quality of medicines;

FIG. 3 is a block diagram of sorting actions to categories in an ELECTRE TRI process;

FIG. 4 is a block diagram illustrating categories defined by boundary conditions in an ELECTRE TRI process;

FIG. 5 is a block diagram illustrating a three category system for inferring the quality level of medicines in an ELECTRE TRI process;

FIG. 6 is a plot of absorbance as a function of wavelength;

FIG. 7 is a block diagram illustrating a five category system for inferring the quality of medicines in an ELECTRE TRI process; and

FIG. 8 is a table illustrating the results of an example of a five category system for inferring the quality of medicines.

The detailed description explains embodiments of the disclosure, together with advantages and features, by way of example with reference to the drawings.

### DETAILED DESCRIPTION

Embodiments of the present invention provide advantages in inferring the quality level of medicines and to classify the tested medicine as being authentic, of low quality or are counterfeit. Embodiments of the present invention provide advantages in inferring the quality level of medicines with a low cost detection system. Embodiments of the present invention provide advantages in inferring the quality level of medicines in remote or less economically developed locations using widely available processing materials.

It has been found that medicines containing pharmaceutical compounds are reactive with UV light. As will be discussed in more detail herein, this characteristic may be utilized to develop a “fingerprint” for a given medicine that allows a pharmacist or other dispensing organization to infer a quality level and thus make an assessment if the compound they received is authentic, of low quality, or counterfeit. As used herein, a medicine or pharmaceutical compound is “authentic” when the tested compound contains the expected concentration level of the active pharmaceutical compound and has impurities below a predetermined threshold. A medicine is considered “low quality” when the expected active pharmaceutical compound contains low concentrations of the active pharmaceutical compound or impurities above the predetermined threshold. The impurities may be a function of poor manufacturing quality control, while low concentrations may be due to either poor manufacturing or point of sale storage conditions (e.g. exposure to moisture, sunlight, heat or beyond an expiration date). A medicine is considered “counterfeit” when it is intentionally manufactured with substantially no active pharmaceutical compounds and is distributed or sold with this knowledge.

As used herein, the term “medicine” or “medication” refers to a compound or substance, whether in tablet, capsule, powdered, liquid or any other suitable form that is used by a person to treat or prevent a medical condition. A medicine will typically include one or more active pharmaceutical compounds that are effective in treating or preventing the medical condition. In some instances, the medicine may be “controlled,” meaning that the medicine may be dispensed by a qualified medical professional (e.g. a doctor or pharmacist). In some instances, the medicine may be purchased or acquired by a person without authorization from a medical professional (e.g. an over-the-counter medicine).

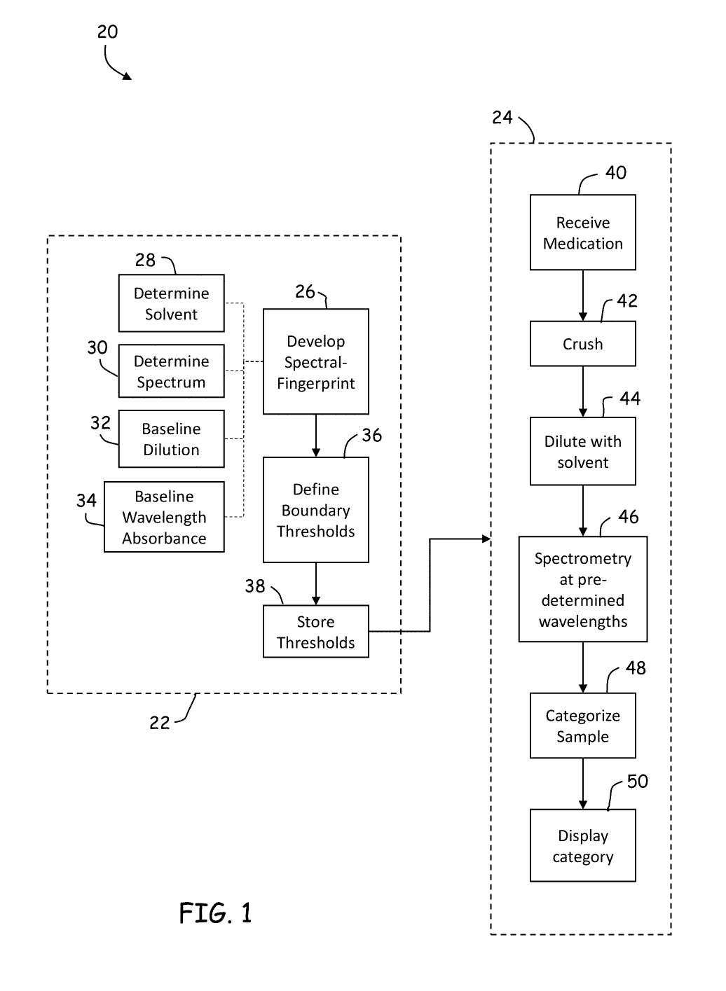

Referring now to FIG. 1, a process 20 is shown for fingerprinting and inferring a medicine. The process 20 is bifurcated into a baseline fingerprinting process 22 and a quality assessment process 24. In the exemplary embodiment, the fingerprinting process 22 is performed in a controlled laboratory setting using control samples of the pharmaceutical compound that are of known authenticity (e.g. from the original manufacturer), while the quality inference process 24 is performed at a remote location. In an embodiment, the remote location may be at pharmacist's office or an apothecary, such as in a low income or middle income area or a developing country.

For the 2017 fiscal year, a definition used by the World Bank is that low-income economies are those with a Gross National Income (GNI) per capita of $1,025 or less in 2015; lower middle-income economies are those with a GNI per capita between $1,026 and $4,035; upper middle-income economies are those with a GNI per capita between $4,036 and $12,475; high-income economies are those with a GNI per capita of $12,476 or more.

The fingerprinting process 22 starts in block 26 with testing the control sample to determine the reactivity of the medicine to UV light and determining the baseline parameters. This may include determining in block 28 the solvent that will dissolve a significant portion of the medicine and excipient. In the exemplary embodiment, the solvent is selected based on the availability of the solvent in the areas (e.g. low and middle income economies) where the testing of process 24 will occur.

In block 30, the spectrum where the medicine is reactive is determined. In an embodiment, this includes determining a discrete number of wavelengths where the medicine is reactive. It should be appreciated that performing the quality assessment process 24 in a full range of the UV spectrum could be problematic for the operators trying to test the compound. A full spectrum UV light system would involve equipment that is considerably expensive and would also increase the amount of time to perform the quality level testing. As such, by determining a relatively small number of UV wavelengths where the medicine is reactive, a cost effective solution that may be performed in a reasonable amount of time may be achieved. In the examples provided herein, four wavelengths were used for the quality level determination. However, in other embodiments, the 2, 3, 4, 5, 6 or 10 wavelengths may be used for example. In still other embodiments, the number of wavelengths used for the quality level determination of a given medicine are experimentally determined to provide desired accuracy with the number of false negatives and false positives being below a threshold.

In block 32, a baseline dilution is determined such that an absorbance within a predetermined range is achieved at the predetermined wavelengths. In the exemplary embodiment, the dilution is determined to provide an absorbance range of 0.25 to 1.25 at the predetermined wavelengths. In block 34, the control sample is tested to determine the baseline wavelength absorbance. In an embodiment, the testing of the control sample is performed by: 1) crushing the control sample with a glass mortar and pestle until it is a consistent fine powder; 2) the massed powder is placed in solution with the corresponding quantity of solvent; 3) the solution is filtered through a gauze pad; and 4) the filtered sample is diluted further to achieve the target absorbance.

With the baseline parameters determined, the process 22 proceeds to block 36 where the boundary thresholds are determined. In the exemplary embodiment, the boundary threshold are determined using an ELECTRE TRI based multi-criteria sorting process to sort samples being tested to the most relevant category using boundaries and uncertainty parameters defined through laboratory experimentation and system optimization. With the boundaries determined, the process 22 proceeds to block 38 where the boundary values are stored, such as in memory of a computing system. In an embodiment, the process 22 also stores the solvent used, the dilution levels and the associated wavelengths where the pharmaceutical compound is reactive.

These stored parameters may then be used in a quality level assessment process 24 that is performed outside of a laboratory environment, such as in a pharmacist's building in a remote location in a low or middle income country. The quality level assessment process 24 starts in block 40 where the pharmacist receives the medication that they wish to test. The pharmacist (or other person tasked with testing the compound) then crushes the medicine in block 42 and dilutes the medicine with a solvent in block 44. In the exemplary embodiment, the pharmacist may receive information on the solvent to use and the dilution amounts from the parameters stored in block 38. The process 24 then proceeds to block 46 where the medicine in the solvent is exposed to the predetermined UV wavelengths defined in process 22 and measures the absorbance of the UV light. The medicine may then be categorized using the boundary thresholds stored in block 48. In one embodiment, the medicine may be categorized as authentic or counterfeit. In this embodiment, any medicine that is not “authenticated” (e.g. has a quality level above a predetermined threshold to infer that the medicine is genuine or contains the expected active pharmaceutical compound) is then categorized as counterfeit (even low quality compounds). In another embodiment, the medicine may be categorized into authentic, low quality and counterfeit classifications. The process 24 then proceeds to block 50 where the categorization is displayed for the pharmacist.

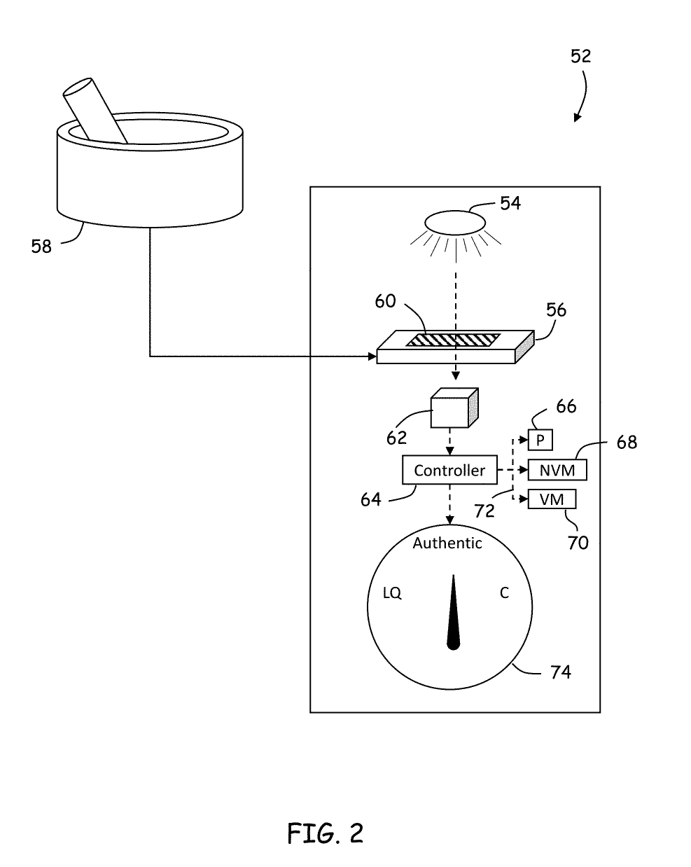

In the exemplary embodiment, the process 24 may be performed by a system 52 (FIG. 2) that is configured to operate in low cost or middle income countries. The system 52 includes a light source 54 that is operable to selectively emit UV light at a predetermined wavelength. In one embodiment, the light source 54 includes one or more filters that selectively transmit the UV light at the predetermined wavelength. In another embodiment, the UV light source 54 may include multiple light generating devices (e.g. light emitting diodes) that each emit light at a different UV wavelength, such as 240, 250, 250 and 270 nanometers for example.

The light source 54 is arranged to emit the light toward a sample holder 56. As discussed above, the pharmacist first crushes the medicine in a mortar and pestle 58 and then adds solvent at the predetermined dilution level. This diluted medicine 60 is placed in a sample holder 56. It should be appreciated that while FIG. 2 illustrates the sample holder 56 as being a planar shape, this is for exemplary purposes and the claimed invention should not be so limited. In other embodiments, the dissolved medicine may be held in other containers, such as a cylindrical tube or other shaped vessel for example, that is placed in the sample holder.

Arranged adjacent the sample holder is a sensor 62. The sensor 62 is arranged to receive the UV light emitted by the light source 54 that has passed through the diluted medicine 60. The sensor 62 transmits a signal in response to receiving the UV light that is indicative of the absorbance of the sample 60.

The sensor 62 is electrically coupled to a controller 64. The system 52 operation is controlled by controller 64. Controller 64 is a suitable electronic device capable of accepting data and instructions, executing the instructions to process the data, and presenting the results. Controller 64 may accept instructions through user interface, or through other means such as but not limited to electronic data card, voice activation means, manually-operable selection and control means, radiated wavelength and electronic or electrical transfer. Therefore, controller 64 can be a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a superconducting computer, a supercomputer, a solid-state computer, a single-board computer, a buffered computer, a computer network, a desktop computer, a laptop computer, a scientific computer, a scientific calculator, a cellular phone or a hybrid of any of the foregoing.

Controller 64 is capable of converting the analog voltage or current level provided by sensor 62 into a digital signal indicative of the level of absorbance of the UV light that passes through the diluted medicine 60. Alternatively, sensor 62 may be configured to provide a digital signal to controller 64, or an analog-to-digital (A/D) converter (not shown) maybe coupled between sensor 62 and controller 64 to convert the analog signal provided by sensor 62 into a digital signal for processing by controller 64. Controller 64 uses the digital signals act as input to various processes for controlling the system 52. The digital signals represent one or more system 52 data including but not limited to absorbance levels and UV light wavelength for example.

Controller 64 may be operably coupled with one or more components of system 52 by data transmission media 72. Data transmission media includes, but is not limited to, twisted pair wiring, coaxial cable, and fiber optic cable. Data transmission media 72 also includes, but is not limited to, wireless, radio and infrared signal transmission systems. In the embodiment shown in FIG. 2, transmission media 72 couples controller 64 to UV light source 54, sensor 62, and display 74. Controller 64 is configured to provide operating signals to these components and to receive data from these components via data transmission media 72.

In general, controller 64 accepts data from sensor 62 and is given certain instructions for the purpose of comparing the data from sensor 62 to predetermined operational parameters (e.g. boundary thresholds). Controller 64 provides operating signals to light source 54 and the display 74. The controller 64 compares the operational parameters to predetermined variances (e.g. boundary thresholds) and categorizes the compound being tested based on the operational parameters. Additionally, the signal may initiate other control methods that adapt the operation of the system 52, such as changing the wavelength of light emitted by the light source 54 or indicating the categorization of the compound on display 74. For example, if sensor 62 measures an absorbance level above a predetermined threshold, this may indicate the diluted medicine 60 is of low quality or is counterfeit.

The categorization of the diluted medicine 60 may be displayed on a user interface or display 74 coupled to controller 64. The user interface may be an LED (light-emitting diode) display, an LCD (liquid-crystal diode) display, a CRT (cathode ray tube) display, or the like. In an embodiment, the user interface may be a plurality of LED lights that indicate a category. A keypad may also be coupled to the user interface for providing data input to controller 64.

In an embodiment, the controller 64 may also be coupled to external computer networks such as a local area network (LAN) and the Internet. LAN interconnects one or more remote computers, which are configured to communicate with controller 64 using a well-known computer communications protocol such as TCP/IP (Transmission Control Protocol/Internet(̂) Protocol), RS-232, ModBus, and the like. Additional systems 52 may also be connected to LAN with the controllers 64 in each of these systems 52 being configured to send and receive data to and from remote computers and other systems 52. In an embodiment, the LAN is connected to the Internet. This connection allows controller 64 to communicate with one or more remote computers connected to the Internet.

In an embodiment, the controller 64 includes one or more processors 66 coupled to a random access memory (RAM) device 70, and a non-volatile memory (NVM) device 68. In other embodiments, the controller 64 may further include a read-only memory (ROM) device, one or more input/output (I/O) controllers, and a LAN interface device.

NVM device 68 is any form of non-volatile memory such as an EPROM (Erasable Programmable Read Only Memory) chip, a disk drive, or the like. Stored in NVM device 68 are various operational parameters for the application code, such as but not limited to the parameters stored in block 38 of FIG. 1. The various operational parameters can be input to NVM device 68 either locally, using a keypad, a remote computer, or remotely via the Internet using a remote computer. It will be recognized that application code can be stored in NVM device 68 rather than a ROM device.

Controller 64 includes operation control methods embodied in application code, such as those shown in FIG. 1. These methods are embodied in computer instructions written to be executed by the one or more processors 66, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, C#, Objective-C, Visual C++, Java, ALGOL (algorithmic language), BASIC (beginners all-purpose symbolic instruction code), visual BASIC, ActiveX, HTML (HyperText Markup Language), Python, Ruby and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software.

### Example 1

As discussed herein, the process 22 includes four initial steps for experimentally determining the boundary thresholds. These four initial steps include: In an embodiment, the testing of the control sample is performed by: 1) crushing the control sample with a glass mortar and pestle until it is a consistent fine powder; 2) the massed powder is placed in solution with the corresponding quantity of solvent; 3) the solution is filtered through a gauze pad; and 4) the filtered sample is diluted further to achieve the target absorbance.

The results of Steps 1 to 4 are presented in Tables 1 and 2 for five pharmaceutical compounds used to develop the spectral fingerprint procedure. The five pharmaceutical compounds include: 1) Albendazole, 2) Mebendazole, 3) Ivermectin, 4) Praziquantel, and 5) Azithromycin. These medicines are cited by the World Health Organizations (WHO) as being needed for battling seven of the world's “neglected tropical diseases,” namely Lymphatic Filariasis, Onchocerciasis, Onchocerciasis, Schistosomiasis, Schistosomiasis, Trachoma, Ascariasis, Hookworm and Trichuriasis. For example: referring to Praziquantel in Table 1: 20 mg sample dissolved in 20 ml of Methanol was adequate for a 5 ml aliquot to be diluted with 5 ml of Methanol and return measures of absorbance between 0.25 and 1.25 (ideal target range) at BWi (see Table 2—experimentally derived target range). The discussion herein refers to only Praziquantel when discussing results.

TABLE 1

| | Albendazole | | Mebendazole | | Ivermectin | | Praziquantel | | Azithromycin | |
|---|---|---|---|---|---|---|---|---|---|---|
| Mass | 25 | mg | 12.5 | mg | 20 | mg | 20 | mg | 20 | mg |
| Solvent | Acetonitrile | | Acetonitrile | | Methanol | | Methanol | | Methanol | |
| Volume | 50 | ml | 25 | mL | 20 | mL | 20 | mL | 20 | mL |
| Aliquot | 1 | ml | 1 | mL | 5 | mL | 5 | mL | 5 | mL |
| Dilutions | 9 | ml | 9 | mL | 5 | mL | 5 | mL | 5 | mL |

| | | | | | |
|---|---|---|---|---|---|
| Wavelenths | 250, 260, | 250, 260, | 240, 250, | 240, 250, | 220, 230, |
| | 270, 280 | 270, 280 | 260, 270 | 260, 270 | 240, 250 |

TABLE 2

| | Wavelenghts (BWi) | | | | | | | |
|---|---|---|---|---|---|---|---|---|
| Medication | 220 | 230 | 240 | 250 | 260 | 270 | 280 | 290 |
| Albendazole | | | | 0.291 | 0.204 | 0.175 | 0.149 | |
| Mebendazole | | | | 0.365 | 0.221 | 0.134 | 0.142 | |
| Invermectin | | | 1.241 | 0.932 | 0.302 | 0.141 | | |
| Praziquantel | | | 0.957 | 0.634 | 0.601 | 0.514 | | |
| Azithromycin | 0.454 | 0.262 | 0.23 | 0.154 | | | | |

In an the ideal laboratory environment, the measures of absorbance in Table 2 could be used directly in a comparative assessment with random samples tested in the field for similarity, and thus inferring quality of the sample relative to the authentic sample. However, due to the simplification of the sample preparation procedure described herein, it is anticipated that there may be variability in measures of absorbance for both the spectral fingerprint and the field sample. Therefore, the absorbance data in Table 2 are not defined as deterministic values, but rather the simple average of 15 independent samples developed for each of the five pharmaceutical compounds (BW_ij). For example, Table 3 contains BW_i absorbance data for 15 samples of Praziquantel. Each sample was independently prepared following Steps 3 and 4 so that a measure of dispersion in absorbance induced by variability in sample preparation could be estimated. The data in Table 3 are used to define category boundaries of the ELECTRE TRI sorting process.

TABLE 3

Wavelegth

| Sample | 240 | 250 | 260 | 270 |
|---|---|---|---|---|
| Sample 1 | 0.883 | 0.589 | 0.54 | 0.457 |
| Sample 2 | 0.934 | 0.62 | 0.528 | 0.452 |
| Sample 3 | 1.141 | 0.764 | 0.559 | 0.475 |
| Sample 4 | 0.973 | 0.632 | 0.624 | 0.522 |
| Sample 5 | 0.904 | 0.612 | 0.557 | 0.476 |
| Sample 6 | 0.954 | 0.615 | 0.603 | 0.512 |
| Sample 7 | 1.035 | 0.705 | 0.666 | 0.563 |
| Sample 8 | 1.025 | 0.689 | 0.657 | 0.555 |
| Sample 9 | 1.069 | 0.695 | 0.684 | 0.573 |
| Sample 10 | 1.218 | 0.791 | 0.798 | 0.681 |
| Sample 11 | 1.024 | 0.697 | 0.665 | 0.574 |
| Sample 12 | 0.956 | 0.642 | 0.611 | 0.536 |
| Sample 13 | 0.783 | 0.52 | 0.534 | 0.468 |
| Sample 14 | 0.746 | 0.487 | 0.496 | 0.427 |
| Sample 15 | 0.706 | 0.459 | 0.493 | 0.436 |
| Average --> | 0.957 | 0.634 | 0.601 | 0.514 |

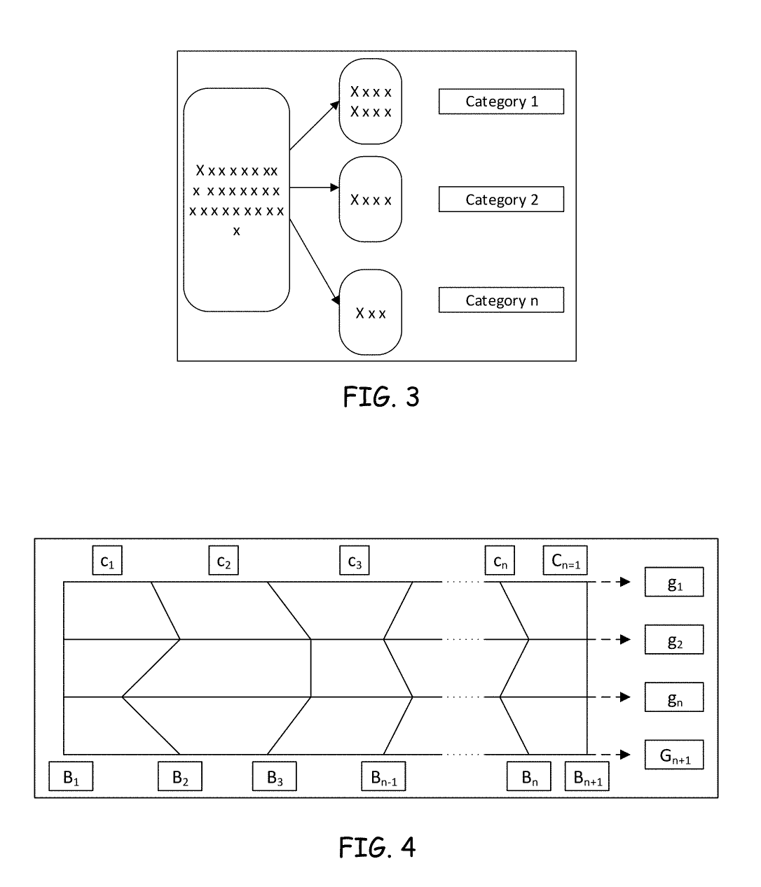

The ELECTRE TRI process was designed to accommodate uncertainty in multi-criteria systems when attempting to sort an item to the most relevant of multiple categories that are defined by boundary conditions. This is conceptually illustrated in FIGS. 3-5, wherein each sample [generically termed an “action” (an)] is sorted into predefined categories (c_n) (see FIG. 3) based on the numeric resemblance of individual criteria of an action [g_j (a)] relative to boundary conditions [(g_j (b_h)] of categories defined (see FIG. 4).

FIG. 4 illustrates an example of a four criteria system with n categories, and n+1 boundaries. These boundaries are depicted in this figure as deterministic (crisp). However, the primary purpose of the ELECTRE TRI is to allow for consideration of uncertainty of input data through the development of three uncertainty thresholds around each boundary condition that are utilized in Equations 1 to 8. These are:
Indifference threshold [q_j (b_h)]: defines a threshold around a category boundary within which differences between the action and boundary [([g)]_j (b_h)-g_j (a)] are ignored through the belief that the action is at-least-as-good-as the boundary condition. A pragmatic interpretation of this threshold is that [(g)]_j (b_h)-g_j (a) is smaller than the inherent uncertainty in the data, and thus should be ignored (i.e.; is scored 1 by Equation 1);
Preference threshold [p_j (b_h)]: defines a threshold around a category boundary outside of which the difference between the action and boundary [([g)]_j (b_h)-g_j (a)] cannot be ignored, and the assertion that the action is at-least-as-good-as the boundary condition is determined to be false. (i.e.; is scored 0 by Equation 1). For the space between the Indifference and Preference Thresholds, [(g)]_j (b_h)-g_j (a) is converted in a linear manner to a score on the set [0,1] by Equation 1; and
Veto threshold [v_j (b_h)]: defines a threshold around a category boundary outside of which the difference between the action and boundary [([g)]_j (b_h)-g_j (a)] dictates that the action cannot be sorted to the category being tested, no matter how well the action performs relative to the other criteria.

Equations 1 through 4, as defined below, partially inform the sorting decision by developing a credibility index σ(a,b_h) as a statement about whether an action is at-least-as-good-as the upper boundary condition of a category (in context of each of the criteria), starting with the boundary condition on the left-hand side of the system (FIG. 3) and moving to the right. Equation 4 yields a score relative to this statement on the set [0,1], where 0 indicates there is no evidence of superiority, and 1 indicates absolute preference.

$$\begin{matrix} \{ \begin{matrix}0 \to if {g}_{j} ( {b}_{h} ) - {g}_{j} ( a ) \geq {p}_{j} ( {b}_{h} ) \\ 1 \to if {g}_{j} ( {b}_{h} ) - {g}_{j} ( a ) \leq {q}_{j} ( {b}_{h} ) \\ \frac{{p}_{j} ( {b}_{h} ) + {g}_{j} ( a ) - {g}_{j} ( {b}_{h} )}{{p}_{j} ( {b}_{h} ) - {q}_{j} ( {b}_{h} )} Otherwise\end{matrix} & ( 1 ) \\ c ( a , {b}_{h} ) = \frac{{Σ}_{j ∈ F} {k}_{j} {c}_{j} ( a , {b}_{h} )}{{Σ}_{j ∈ F} {k}_{j}} & ( 2 ) \\ {d}_{j} ( a , {b}_{h} ) = \{ \begin{matrix}0 \to if {g}_{j} ( {b}_{h} ) - {g}_{j} ( a ) \leq {p}_{j} ( {b}_{h} ) \\ 1 \to if {g}_{j} ( {b}_{h} ) - {g}_{j} ( a ) > {v}_{j} ( {b}_{h} ) \\ \frac{{g}_{j} ( {b}_{h} ) - {g}_{j} ( a ) - {p}_{j} ( {b}_{h} )}{{v}_{j} ( {b}_{h} ) - {p}_{j} ( {b}_{h} )} Otherwise\end{matrix} & ( 3 ) \\ σ ( a , {b}_{h} ) = c ( a , {b}_{h} ) {Π}_{j ∈ F} \frac{1 - {d}_{j} ( a , {b}_{h} )}{1 - c ( a , {b}_{h} )} where \text{:} {d}_{j} ( a , {b}_{h} ) \geq c ( a , {b}_{h} ) , 1 otherwise & ( 4 )\end{matrix}$$

To complete the process, a second credibility index σ(b_h,a) is developed in the reverse order: is the boundary condition at-least-as-good-as the action relative to the lower boundary of each category, starting from the right and moving to the left. Equation 8 again yields a score on the set [0,1]. For this, Equations 1 through 4 are adapted slightly as Equation 1 through 8:

$$\begin{matrix} {c}_{j} ( {b}_{h} , a ) = \{ \begin{matrix}0 \to if {g}_{j} ( a ) - {g}_{j} ( {b}_{h} ) \geq {p}_{j} ( {b}_{h} ) \\ 1 \to if {g}_{j} ( a ) - {g}_{j} ( {b}_{h} ) \leq {q}_{j} ( {b}_{h} ) \\ \frac{{p}_{j} ( {b}_{h} ) + {g}_{j} ( {b}_{h} ) - {g}_{j} ( a )}{{p}_{j} ( {b}_{h} ) - {q}_{j} ( {b}_{h} )} Otherwise\end{matrix} & ( 5 ) \\ c ( {b}_{h} , a ) = \frac{{Σ}_{j ∈ F} {k}_{j} {c}_{j} ( a , {b}_{h} )}{{Σ}_{j ∈ F} {k}_{j}} & ( 6 ) \\ {d}_{j} ( {b}_{h} , a ) = \{ \begin{matrix}0 \to if {g}_{j} ( a ) - {g}_{j} ( {b}_{h} ) \leq {p}_{j} ( {b}_{h} ) \\ 1 \to if {g}_{j} ( a ) - {g}_{j} ( {b}_{h} ) > {v}_{j} ( {b}_{h} ) \\ \frac{{g}_{j} ( a ) - {g}_{j} ( {b}_{h} ) - {p}_{j} ( {b}_{h} )}{{v}_{j} ( {b}_{h} ) - {p}_{j} ( {b}_{h} )} Otherwise\end{matrix} & ( 7 ) \\ σ ( {b}_{h} , a ) = c ( a , {b}_{h} ) {Π}_{j ∈ F} \frac{1 - {d}_{j} ( a , {b}_{h} )}{1 - c ( a , {b}_{h} )} where \text{:} {d}_{j} ( {b}_{h} , a ) \geq c ( a , {b}_{h} ) , 1 otherwise & ( 8 )\end{matrix}$$

A credibility threshold (λ) is defined by the operator as a minimum value of σ(a,b_h) and σ(b_h,a) in order for the “at-least-as-good-as” statements to be considered valid (0.75, for example). This can result in the four logical outcomes listed below that are subsequently used to sort an action to a category.

Logic Outcome 1: σ(a,b_h),and σ(b_h,a) are in conflict
1a) σ(a, b_h)>λ and σ(b_h, a)>λ: a is indifferent to b_h
1b) σ(a, b_h)<λ and σ(b_h, a)<λ: a is incompatible to b_h

Logic Outcome 2: σ(a,b_h),and σ(b_h,a) are in agreement
2a) σ(a, b_h)>λ and σ(b_h, a)<λ: a is preferred to b_h
2b) σ(a, b_h)<λ and σ(b_h a)>λ: b_h is preferred to a

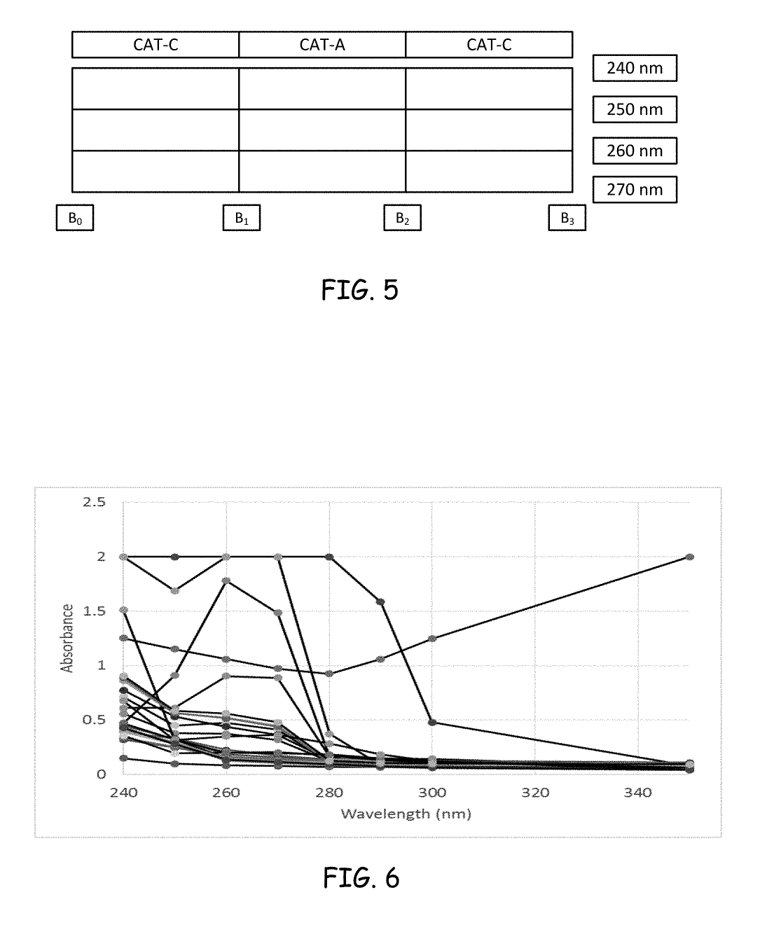

The ELECTRE TRI process defined above was implemented in the context of a three category system (illustrated in FIG. 5) that corresponds to the quality level of a tested medicine (e.g. a candidate sample). In FIG. 5, CAT-A (Authentic) is centrally located because a low quality sample can fail to be sorted to CAT-A for measures of absorbance that are either too high or too low. Thus, any sample that fails to be sorted to CAT-A is by definition sorted to either of the CAT-C (Counterfeit) categories. This includes all samples specifically sorted to CAT-C by the algorithm, as well as all samples that fall under the ‘1a’ and ‘1b’ logical outcome of “incomparable” and “indifferent”, which for safety must be sorted to (CAT-C).

All boundary conditions in the system illustrated in FIG. 5 are defined by the boundaries of CAT-A: 1) lower boundary of the left-hand CAT-C has a default condition of zero (0% absorbance), 2) upper boundary for the right-hand CAT-C has a default condition of absorbance=2 (99% absorbance), 3) the remaining boundaries are defined by the upper and lower boundaries of CAT-A, which were defined through a measure of dispersion in the 15 samples of high quality medication (Table 3 are examples for Praziquantel). The average deviation from mean absorbance for the 15 samples for each of the 5 medications (([(BW)]_ij)) was 25%. Thus, the upper and lower boundaries for CAT-A were defined as ±25% from (([BW)]_ij)).

The category boundaries of conceptually illustrated in FIG. 3 (specific to Praziquantel) are defined in Table 4 using this method. Here, g1(b1) is the lower boundary condition of CAT-A, and g1(b2) is the upper boundary condition. Boundaries g1(bo) and g1(b3) are not shown, but as defined as zero and 2 (respectively) for all criteria.

In this embodiment, the uncertainty parameters were defined for convenience (see Table 4): 1) Indifference Threshold was defined as zero because the function of this parameter was already considered by the way the upper and lower boundaries for CAT-A were defined, and 2) Preference and Veto Thresholds were defined through an iterative process that minimized the total number of false positives and false negatives across all five tested medicines. This allowed for the uncertainty thresholds to be held constant for the five medications in order to maintain consistency and ease of use of the system.

TABLE 4

| | | | | | Uncertainty | |
|---|---|---|---|---|---|---|
| Category Upper Boundaries | | | | | Thresholds | |
| Criteria--> | 240 | 250 | 260 | 270 | qⱼ (bₕ) | 0 |
| | | | | | pⱼ (bₕ) | 0.05 |
| gⱼ (b₂) | 1.20 | 0.79 | 0.75 | 0.64 | vⱼ (bₕ) | 0.1 |
| gⱼ (b₁) | 0.72 | 0.48 | 0.45 | 0.39 | σ | 0.85 |

In order to determine if the procedure was able to differentiate medicine samples having the desired quality level from a background of non-authentic samples (proxy low quality/counterfeit), random substances (approximately 20 drawn from Table 5) were prepared following Steps 3 and 4 cited above for each of the five medications. This included at least four authentic samples so that there were a total of 25 samples for each medication.

TABLE 5

2′-4′-dihydroxy- acetophenone
3-bromo-4-hydroxy benzaldehyde
3-chloro-4-hydroxy benzaldehyde
3-chloro-4-mehyoxy aniline
3-chloxy-4-hydroxy benzaldehyde
3-ethoxy-4-hydroxy Benzaldehyde
3-hydroxy phenyl boronic acid
4-biphenyl methanol
4-chlorobenzyl alcohol
4-hydroxyphenyl acetic acid
4-nitrobenxzyl Alcohol
Albendazole
Azithromycin
Azithromycin & Praziquantel
boric anhydride
Coffee
coffee creamer
diacetoxylodol benzene
Disodium p-nitro phoenyl phosphate
dodecanoic acid
Equal
Ivermectin
Magnesium Sulfate
Mebendazole
Mebendazole with Sodium Chloride
methyl-triphenylphosphonium bromide
MgSO4
Myristic Acid
NaCl
NaCl with Albendazole
NaHCO3
Palmetic Acid
Pepper
Phenyl Boronic Acid
Phenylboronic Acid
Praziquantel
Praziquantel & Ivermectin
Sodium Bicarbonate
Sodium butryate
Sodium Chloride
Sodium p-toluene Sulfonate
sodium p-toluene sulfonate & Albendazole
Sodium Sulfate
Splenda
Sugar
Sugar & Albendazole
Sweet & Low
Sweet & Low with Albendazole

FIG. 6 illustrates the spectral fingerprint for each of the 25 samples used to validate the system for Praziquantel in order to demonstrate that random substances ‘buried’ authentic samples in a set of random noise, and that ELECTRE TRI based spectral fingerprint system then extracts authentic samples from this noise. As a note: FIG. 6 is presented with extraneous absorbance data (wavelengths greater than 270 nm) for all 25 samples in order to demonstrate that measures of absorbance at discrete wavelength spaced at 10 nm reasonably approximates the continuous absorbance profiles of a substance.

The spectral fingerprint for the 25 candidate samples (see Table 6 for Praziquantel) were inputted to the ELECTRE TRI algorithm (Equations 1 to 8) using category boundaries and uncertainty parameters defined in Table 4. The resulting logic dictated the ‘credibility’ of sorting the 25 samples to the categories in FIG. 5.

TABLE 6

| | Wavelength | | | | |
|---|---|---|---|---|---|
| Action | 240 | 250 | 260 | 270 | Factual Substance |
| a1 | 0.47 | 0.91 | 1.78 | 1.49 | Phenylboronic Acid |
| a2 | 0.56 | 0.38 | 0.37 | 0.32 | Azithromycin & Praziquantel |
| a3 | 1.51 | 0.32 | 0.15 | 0.14 | Sodium Nitrate |
| a4 | 0.71 | 0.45 | 0.47 | 0.41 | Praziquantel |
| a5 | 0.15 | 0.10 | 0.08 | 0.08 | Myristic Acid |
| a6 | 0.61 | 0.61 | 0.90 | 0.89 | 4-chlorobenzyl Alcohol |
| a7 | 2.00 | 2.00 | 2.00 | 2.00 | 4-biphenyl methanol |
| a8 | 0.39 | 0.33 | 0.23 | 0.17 | Sodium Sulfite |
| a9 | 0.32 | 0.25 | 0.16 | 0.14 | Sodium Chloride |
| a10 | 0.34 | 0.25 | 0.16 | 0.14 | Sodium Bicarbonate |
| a11 | 0.78 | 0.53 | 0.44 | 0.37 | Praziquantel & Ivermectin |
| a12 | 0.45 | 0.33 | 0.18 | 0.16 | Magnesium Sulfate |
| a13 | 2.00 | 1.69 | 2.00 | 2.00 | methyl-triphenylphosphonium |
| | | | | | bromide |
| a14 | 0.86 | 0.57 | 0.52 | 0.45 | Praziquantel |
| a15 | 0.39 | 0.28 | 0.15 | 0.12 | Sodium Sulfate |
| a16 | 0.36 | 0.19 | 0.20 | 0.21 | Sweet n' Low |
| a17 | 0.42 | 0.29 | 0.15 | 0.13 | Sugar |
| a18 | 0.41 | 0.29 | 0.14 | 0.12 | Splenda |
| a19 | 0.89 | 0.57 | 0.52 | 0.44 | Praziquantel |
| a20 | 0.47 | 0.32 | 0.20 | 0.20 | Coffee |
| a21 | 0.43 | 0.29 | 0.13 | 0.10 | Sugar |
| a22 | 0.68 | 0.32 | 0.35 | 0.36 | Sweet n' Low |
| a23 | 0.43 | 0.28 | 0.14 | 0.11 | Splenda |
| a24 | 1.25 | 1.15 | 1.06 | 0.97 | Pepper |
| a25 | 0.91 | 0.58 | 0.56 | 0.48 | Praziquantel |

Table 7 presents results of this process for Praziquantel, presented in a manner intended to aid the overall comprehension of the results for the novice ELECTRE TRI reader. For this, the arrows [“←” and “→”] are representative of the ELECTRE TRI mathematical sorting logic, and should be read as either being in agreement or disagreement for each boundary condition (CAT-C Powell-to-CAT-A, and CAT-A-to-CAT-C [upper]):
In agreement: the arrows ‘point’ to the category into which any random sample was sorted. For example, the logic associated with sample ‘a4’ of Table 6 clearly demonstrates agreement for sorting the sample to CAT-A. The factual substance was Praziquantel, and thus it is determined that this sample was sorted ‘correctly’ (True Positive). For sample ‘a5’ the logic clearly sorts the sample to CAT-C. The substance was factually a mixture of Myristic Acid, and thus it is determined that this sample was sorted ‘correctly’ as well; and
In disagreement: the sample must be sorted to CAT-C because the ELECTRE TRI algorithm is unable to sort to any one specific category. For example, sample ‘a1’ is sorted to CAT-C because the algorithm is unable to determine the appropriate category. Given that the sample is factually Phenylboronic Acid, this sample is sorted correctly as CAT-C.

TABLE 7

| | | CAT-C to | | CAT- A to | | |
|---|---|---|---|---|---|---|
| Action | | CAT-A Barrier | | CAT-C Barrier | | Factual Substance |
| a1 | CAT-C | not | CAT-A | not | CAT-C | Phenylboronic Acid |
| | | comparable | | comparable | | |
| a2 | | <-- | | <-- | | Azithromycin & |
| | | | | | | Praziquantel |
| a3 | | not | | not | | Sodium Nitrate |
| | | comparable | | comparable | | |
| a4 | | --> | | <-- | | Praziquantel |
| a5 | | <-- | | <-- | | Myristic Acid |
| a6 | | not | | not | | 4-chlorobenzyl |
| | | comparable | | comparable | | Alcohol |
| a7 | | --> | | --> | | 4-biphenyl methanol |
| a8 | | <-- | | <-- | | Sodium Sulfite |
| a9 | | <-- | | <-- | | Sodium Chloride |
| a10 | | <-- | | <-- | | Sodium Bicarbonate |
| a11 | | not | | <-- | | Praziquantel & |
| | | comparable | | | | Ivermectin |
| a12 | | <-- | | <-- | | Magnesium Sulfate |
| a13 | | --> | | --> | | methyl-triphenyl- |
| | | | | | | phosphonium bromide |
| a14 | | --> | | <-- | | Praziquantel |
| a15 | | <-- | | <-- | | Sodium Sulfate |
| a16 | | <-- | | <-- | | Sweet n' Low |
| a17 | | <-- | | <-- | | Sugar |
| a18 | | <-- | | <-- | | Splenda |
| a19 | | --> | | <-- | | Praziquantel |
| a20 | | <-- | | <-- | | Coffee |
| a21 | | <-- | | <-- | | Sugar |
| a22 | | <-- | | <-- | | Sweet n' Low |
| a23 | | <-- | | <-- | | Splenda |
| a24 | | --> | | --> | | Pepper |
| a25 | | --> | | <-- | | Praziquantel |

Results of Samples ‘a2’ & ‘a11’ in Table 7 are notable and worthy of further discussion. Each of these samples were intended to mimic low quality field samples by mixing an authentic sample of the medication with other substances. Action a2 was factually Praziquantel mixed with Azithromycin, and Action all was Praziquantel mixed with Ivermectin. In each case the ELECTRE TRI sorting process sorted the sample to CAT-C. Similar findings resulted in the other five medications (not shown here) tested in this research, wherein these ‘low quality’ samples were sorted to CAT-C.

### Example 2

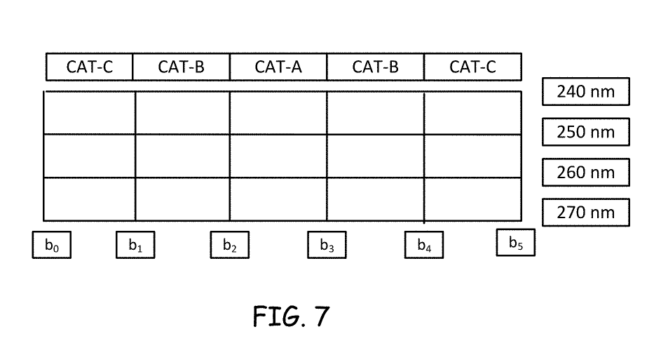

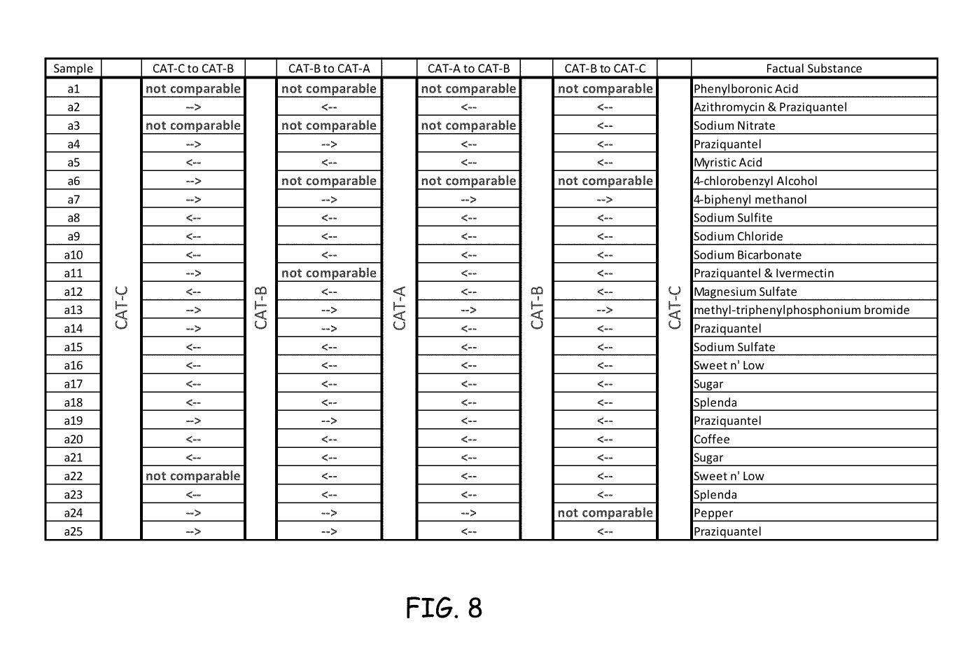

In order to enhance the resolution of the ELECTRE TRI sorting algorithm so that similar low quality samples could be identified as such, a five category system (FIG. 7) was tested that included a “CAT-B” (low quality) located between CAT-A and CAT-C. CAT-A was defined in the same manner as for the three category system of FIG. 6, thus had the same boundaries. CAT-B outer boundaries were defined arbitrarily as having equal width as CAT-A. The uncertainty parameters (Table 8) were held constant relative to the three category system for ease of use. Result of this increased resolution are shown in FIG. 8 using the same system as with Table 7.

TABLE 8

| | | | | | Uncertainty | |
|---|---|---|---|---|---|---|
| Category Upper Boundaries | | | | | Thresholds | |
| Criteria--> | 240 | 250 | 260 | 270 | qⱼ (bₕ) | 0 |
| gⱼ (b₅) | 1.49 | 0.99 | 0.94 | 0.80 | pⱼ (bₕ₎ | 0.05 |
| gⱼ (b₃) | 1.20 | 0.79 | 0.75 | 0.64 | vⱼ (bₕ) | 0.1 |
| gⱼ(b₂) | 0.72 | 0.48 | 0.45 | 0.39 | σ | 0.85 |

| | | | | |
|---|---|---|---|---|
| gⱼ (b₁) | 0.54 | 0.36 | 0.34 | 0.29 |

Tables 9, 10 and 11 summarize the result of for all five medications used with the ELECTRE TRI spectral fingerprint process.

### Three Category Authentic—Counterfeit System:

Table 9 shows that that for Albendazole, Praziquantel, Ivermectin, Azithromycin and Mebendazole, 19 of 21 authentic samples were sorted to CAT-A, and one non-authentic (e.g. low quality) sample was sorted to CAT-A. For CAT-A this translates to 10% false negatives, and 1% false positives (see Table 11). For non-authentic samples (CAT-C), 104 of 105 samples were correctly sorted to CAT-C, with 2 of 21 authentic samples sorted to CAT-C (false negatives).

### Five Category Authentic—Low Quality—Counterfeit System:

The results for the five category system presented in Table 10 are more nuanced because the binary nature of the three category system in Table 9 cannot be repeated. However, the results are promising and demonstrate that increasing the resolution has some benefit. Specifically, FIG. 8 clearly indicates that Action a2 was sorted to the CAT-B, and Action all was indirectly sorted to CAT-B because of the uncertainty (not comparable) of sorting between the CAT-B and CAT-A boundary. Each of these were, in fact, ‘low quality’ samples, and thus defined as being sorted property.

TABLE 9

| 3 Category System | |
|---|---|
| CAT A | CAT C |

| | Correct | Incorrect | Correct | Incorrect |
|---|---|---|---|---|
| Albendazole | 3 | 0 | 22 | 0 |
| Praziquantel | 4 | 0 | 21 | 0 |
| Ivermectin | 3 | 0 | 21 | 1 |
| Azithromycin | 4 | 1 | 19 | 1 |
| Mebendazole | 5 | 0 | 21 | 0 |

TABLE 10

| | 5 Category System | | | | | |
|---|---|---|---|---|---|---|
| | CAT A | | CAT B | | CAT C | |
| | | Incor- | | Incor- | | Incor- |
| | Correct | rect | Correct | rect | Correct | rect |
| Albendazole | 3 | 0 | 1 | 0 | 19 | 2 |
| Praziquantel | 4 | 0 | 2 | 0 | 19 | 0 |
| Ivermectin | 3 | 0 | 1 | 1 | 20 | 0 |
| Azithromycin | 4 | 1 | 1 | 4 | 15 | 0 |
| Mebendazole | 5 | 0 | 1 | 0 | 19 | 0 |

TABLE 11

| | |
|---|---|
| 3-Category System | 5 Category System |

| CAT | Correct | Incorrect | Correct | Incorrect |
|---|---|---|---|---|
| CAT-A | 90% | 1% | 90% | 1% |
| CAT-B | — | — | 67% | 4% |
| CAT-C | 98% | 10% | 98% | 6% |

The low rate (65%) of true positives for CAT-B in Table 9 challenges this benefit, but does not negate its purpose. This is because any medicine that is not sorted to the CAT-A should not be consumed, and the five category system is as effective as the three category system in this regard. Thus, the benefit of the higher resolution of the five category system is purely informational. For example, given that some sample is sorted to CAT-B, it is assumed that the sample is not of a quality for consumption, if for no other reason than it should be assumed that it is of very poor quality. The question thus arises: why is it poor quality? The ‘quality’ is due to either, 1) poor manufacturing quality control, 2) transportation or storage conditions (high heat, humidity, etc. . . . ), or 3) expiration date. Thus, knowledge that a sample is low quality allows for cause to be investigated and mitigated through surveillance (poor quality manufacture) and/or education of the pharmacist (storage and expiration date).

It has been found that ELECTRE TRI provides an impact on false positive and false negative rates. If the full continuous absorbance profile of a medicine in solution were used in this procedure, rather than the four discrete wavelength spectral fingerprint system, any number of standard statistical procedures could be used to infer a measure of quality for any random sampled tested, including goodness-of-fit tests such as Allison-Darling or Kolmogorov-Smirnov that ‘fit’ a theoretical model to a known profile. For example, if a field sample profile and known sample profile were determined to be ‘good fits’, it would logically be inferred that the field sample was authentic. This is because the probability of any two substances in insolation having near identical profiles trends towards zero, and thus the rate of false positives would be near zero.

Conversely, the likelihood of any random non-authentic substance (e.g. low quality) being sorted to CAT-A increases as the number of discrete wavelengths used in the procedure decreases, until just a single measure of absorbance is captured. At this point an unknown rate of false positives would occur simply because there is an unknown number of random substances in solution that would yield a measure of absorbance within the tolerance for being sorted to CAT-A, if not countered with a second (or more) measure of absorbance at another wavelength.

Thus, somewhere between using the complete and continuous absorbance profile of a medication in solution, and a single measure of absorbance, there is a near optimal number of discrete BWi that satisfy the multiple objectives of increasing or maximizing the accessibility of the testing procedure, and reducing or minimizing the number of false positives and false negatives.

Determining whether 2, 3, 4, 5, 6 or 10 wavelengths of UV light provides may be different for every medication. In one embodiment, the number of wavelengths of UV light is less than or equal to 10 wavelengths of UV light. In another embodiment, the number of wavelengths is less than or equal to six wavelengths of UV light. In still another embodiment, the number of wavelengths is less than or equal to four wavelengths of UV light. However, what can be demonstrated is the impact of the ELECTRE TRI sorting algorithm on the rate of false positives and false negatives. For this, Table 12 repeats the data of Table 9, but with the exclusion of the ELECTRE TRI sorting algorithm by replacing it with a simpler rule that states: “if a measure of absorbance at any baseline wavelength (([(BW)]_ij)) deviates from the mean absorbance (Table 2) more than 25%, the sample is sorted to CAT-C”. The results of this system are presented in Table 14, wherein it is clear that the rate of false negatives increases from 10% (Table 9) to 33%, though the number of false positives remains at 1%.

TABLE 12

| 3 Category System (w/o ELECTRE TRI) | |
|---|---|
| CAT A | CAT C |

| | Correct | Incorrect | Correct | Incorrect |
|---|---|---|---|---|
| Albendazole | 1 | 0 | 22 | 2 |
| Praziquantel | 3 | 0 | 21 | 1 |
| Ivermectin | 3 | 0 | 21 | 1 |
| Azithromycin | 3 | 1 | 19 | 2 |
| Mebendazole | 4 | 0 | 20 | 1 |

TABLE 13

3-Category System

| CAT | Correct | Incorrect |
|---|---|---|
| CAT-A | 67% | 1% |
| CAT-B | — | — |
| CAT-C | 99% | 18% |

Embodiments herein provide for a method for detecting low quality and counterfeit medications in areas with low resources, such as in low income and medium income countries. In an embodiment, to accomplish this the continuous absorbance profile of the medicine in the UV spectrum was replaced in the testing regiment with four discrete readings of absorbance in the region of the spectrum that medicine is active. The result shows positive results for differentiation between ‘authentic’ and ‘non-authentic’ samples in a binary manner, as well as some promise for differentiating between ‘authentic’ ‘low quality’ and ‘counterfeit’ samples.

In an embodiment, the ELECTRE TRI sorting process was used, to overcome the inherent randomness of the sample preparation process, and subsequent variation in the reading of absorbance. Without ELECTRE TRI sorting there is a 33% false negative rate. The inclusion of ELECTE TRI sorting decreases this rate to 10%, which offers substantive value to the user in detecting low quality and counterfeit compounds in random testing at point-of-care.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A method for inferring the quality level of a medicine, the method comprising:
diluting the medicine with a solvent;
measuring levels of absorption of UV light at a plurality of predetermined wavelengths;
categorizing the quality of the medicine based at least in part on an ELECTRE TRI process using the measured absorption levels; and
displaying the category to an operator.

2. The method of claim 1, wherein the categorization is further based in part on an uncertainty threshold.

3. The method of claim 1 wherein the categorization indicates the medicine is authentic or counterfeit.

4. The method of claim 3 wherein the categorization further indicates when the medicine is of low quality.

5. The method of claim 1 further comprising:
developing a spectral fingerprint for the medicine;
defining boundary thresholds for the categorization; and
storing the thresholds.

6. The method of claim 5 wherein the developing of the spectral fingerprint further includes:
determining the solvent;
determining the UV spectrum range;
determining a baseline dilution; and
determining the predetermined wavelengths and baseline absorbance associated with the predetermined wavelengths.

7. The method of claim 6, wherein the storing of the thresholds further includes storing the predetermined wavelengths and baseline absorbance.

8. The method of claim 7, wherein the baseline absorbance is determined from a plurality of samples, and the boundary thresholds are based at least in part on a mean absorbance for the plurality of samples.

9. The method of claim 1, wherein the measuring of the absorption of UV light is performed at less than or equal to 10 wavelengths of UV light.

10. The method of claim 9, wherein the measuring of the absorption of UV light is performed at less than or equal to six wavelengths of UV light.

11. The method of claim 10, wherein the measuring of the absorption of UV light is performed at less than or equal to four wavelengths of light.

12. A system for inferring the quality level of a medicine, the system comprising:
a light source that transmits UV light at a plurality of predetermined wavelengths;
a sensor that measures the UV light;
a sample holder operable to receive a sample of the medicine diluted by a solvent, the sample holder disposed between the sensor and the light source;
one or more processors that execute non-transitory computer readable instructions, the computer readable instructions comprising:
measuring levels of absorption of UV light at the plurality of predetermined wavelengths;
categorizing the quality of the medicine based at least in part on an ELECTRE TRI process using the measured absorption levels; and
displaying the category to an operator.

13. The system of claim 12, wherein the categorization is further based in part on an uncertainty threshold.

14. The system of claim 12, wherein the categorization indicates the medicine is authentic or counterfeit.

15. The system of claim 14, wherein the categorization further indicates when the medicine is of low quality.

16. The system of claim 12, further comprising memory operably coupled to the one or more processors, wherein the memory stores the computer readable instructions and boundary threshold data for the categorization.

17. The system of claim 16, wherein the memory further stores data on the solvent, baseline absorbance and the plurality of predetermined wavelengths.

18. The system of claim 12, wherein the plurality of predetermined wavelengths is less than or equal to 10 wavelengths of UV light.

19. The system of claim 18, wherein the plurality of predetermined wavelengths is less than or equal to 6 wavelengths of UV light.

20. The system of claim 19, wherein the plurality of predetermined wavelengths is less than or equal to 4 wavelengths of UV light.
